(19) United States
(12) Patent Application Publication
(10) Pub. No.: US 2025/0284634 A1
(43) Pub. Date: Sep. 11, 2025

(54) METHOD AND SYSTEM FOR DATA TRANSMISSION, CONTROLLER, AND STORAGE MEDIUM

(71) Applicant: INNOGRIT TECHNOLOGIES CO., LTD., Shanghai (CN)

(72) Inventors: Jian WU, Shanghai (CN); Jie CHEN, Shanghai (CN); Dishi LAI, Shanghai (CN); Zhengtian FENG, Shanghai (CN)

(21) Appl. No.: 19/065,841

(22) Filed: Feb. 27, 2025

(30) Foreign Application Priority Data
Mar. 11, 2024 (CN) 202410275874.1

(51) Int. Cl. G06F 12/02

(52) U.S. Cl. CPC G06F 12/0246; G06F 2212/2022; G06F 2212/72

(57) ABSTRACT

A method for data transmission, a controller, and a storage medium are provided. In response to receiving a write command to be processed, a data size and an address form corresponding to the write command are acquired; the write command is divided based on a transmissible data size corresponding to a flash memory channel for data transmission and a data size corresponding to the write command to obtain at least one sequentially executed sub-command, each of which has a corresponding sub-data size and corresponding sub-address information; a channel state of at least one flash memory channel is polled, and a sub-command is assigned to the flash memory channel when the channel state of the flash memory channel is idle; and a logical data block is acquired based on the sub-address information corresponding to the sub-command, and written into a NAND flash memory through the flash memory channel.

### CROSS-REFERENCE TO RELATED APPLICATION

This application claims priority to Chinese Patent Application No. 202410275874.1, filed on Mar. 11, 2024, which is hereby incorporated by reference in its entirety.

### TECHNICAL FIELD

The present disclosure relates to the field of data transmission, in particular to a method and a system for data transmission, a controller, and a storage medium.

### BACKGROUND

NVMe (Non-Transitory Memory Express) is a bus transmission protocol based on a logical interface of a device. It specifies a standard protocol for accessing a non-transitory storage medium, such as a solid-state drive (SSD) with a flash memory, through a bus (typically the PCIe bus protocol), and is a protocol for communication between a host and the SSD. NVMe data transmission commands are used for data transmission between the host and the SSD, including a write command and a read command. These two types of commands of NVMe are issued by the host, and a host controller (hereinafter referred to as a master control) for a non-transitory memory is responsible for executing the commands. For the write command, the master control proactively reads data from a host memory and writes the data into a non-transitory storage medium. For the read command, the master control proactively reads data from the non-transitory storage medium and writes the data into the host memory. During data transmission, a master control chip for the SSD typically needs to support parallel access to multiple NAND channels. The related technology requires that data to be written into each channel be first stored in a buffer, and then transmitted through the NAND channels, which increases both the occupied area and the cost of the master control chip.

### SUMMARY

In view of the above, the present disclosure provides a method and a system for data transmission, a controller, and a storage medium, aiming at reducing the demand for data buffer space during data transmission.

According to a first aspect of the present disclosure, there is provided a method for data transmission, comprising:
acquiring, in response to receiving a write command to be processed, a data size and an address form corresponding to the write command;
dividing the write command based on a transmissible data size corresponding to a flash memory channel for data transmission, and the data size corresponding to the write command to obtain at least one sub-command, each of which has a corresponding sub-data size;
polling a channel state of at least one flash memory channel and assigning the sub-command based on the channel state;
determining sub-address information corresponding to the sub-command; and
acquiring a logical data block based on the sub-address information corresponding to the sub-command, and writing the logical data block into a NAND flash memory through the flash memory channel.

In one possible implementation, the address form comprises a start address for data to be written, and a data address list containing a plurality of storage addresses for the data to be written following the start address.

In one possible implementation, determining the sub-address information corresponding to the sub-command comprises:
calculating a sub-start address and a corresponding page offset based on seg_prp_ptr=Mod((seg_size*seg_num+prp_ofst−seg_ofst)/page_size) and seg_prp_ofst=|(seg_size*seg_num+prp_ofst−seg_ofst)/page_size|, respectively, where seg_size represents a sub-data size corresponding to the sub-command, seg_num represents an execution order corresponding to the sub-command, prp_ofst represents a page offset of the start address, seg_ofst represents an offset of a logical data block corresponding to a first sub-command, and page_size represents a size of a data page that stores the data address list; and
determining corresponding sub-address information based on a position of the sub-start address and the page offset corresponding to the sub-command.

In one possible implementation, the sub-data size corresponding to the sub-command is smaller than or equal to the transmissible data size.

In one possible implementation, polling the channel state of the at least one flash memory channel and assigning the sub-command based on the channel state comprises:
in response to presence of a flash memory channel with the channel state being completely idle, assigning a sub-task to the flash memory channel; and
in response to absence of a flash memory channel with the channel state being completely idle, assigning a sub-task to at least one flash memory channel with the channel state having a highest degree of idleness.

In one possible implementation, the method further comprises:
dividing the logical data block based on a preset size to obtain a plurality of sub-logical data blocks; and
performing, by the flash memory channel, data transmission in units of the sub-logical data blocks.

In one possible implementation, the channel state is determined based on a count of a command counter, and the smaller a count value corresponding to the channel state, the higher a degree of idleness.

According to a second aspect of the present disclosure, there is provided a controller, comprising:
a write command receiving module configured to receive a write command in a host memory and acquire a data size and an address form corresponding to the write command;
a NAND flash memory controller configured to divide the write command based on a transmissible data size corresponding to a flash memory channel for data transmission and the data size corresponding to the write command to obtain at least one sub-command;
a PRP pointer calculation module configured to determine sub-address information corresponding to each sub-command;
a PRP address reading module configured to acquire a storage address for a logical data block corresponding to the sub-command based on the sub-address information; and
a data writing module configured to read a corresponding logical data block from the host memory based on the storage address for the logical data block,
where the NAND flash memory controller is further configured to receive the logical data block and write the logical data block into a corresponding flash memory channel to write the logical data block into a NAND flash memory through the flash memory channel.

According to a third aspect of the present disclosure, there is provided a system for data transmission, comprising: a processor, and a memory for storing processor executable instructions, where the processor is configured to, upon executing the instructions stored in the memory, implement the method described above.

According to a fourth aspect of the present disclosure, there is provided a non-transitory computer readable storage medium storing computer program instructions thereon, where the computer program instructions, when executed by a processor, implement the method described above.

According to a fifth aspect of the present disclosure, there is provided a computer program product, comprising computer readable code, or a non-transitory computer readable storage medium carrying computer readable code, where when the computer readable code runs in a processor of an electronic apparatus, the processor of the electronic apparatus executes the method described above.

According to an embodiment of the present disclosure, in response to receiving a write command to be processed, a data size and an address form corresponding to the write command are acquired; the write command is divided based on a transmissible data size corresponding to a flash memory channel for data transmission and a data size corresponding to the write command to obtain at least one sequentially executed sub-command, each of which has a corresponding sub-data size and corresponding sub-address information; a channel state of at least one flash memory channel is polled, and a sub-command is assigned to the flash memory channel when the channel state of the flash memory channel is idle; and a logical data block is acquired based on the sub-address information corresponding to the sub-command, and the logical data block is written into a NAND flash memory through the flash memory channel. By dividing the write command, the present disclosure avoids the need for hardware to store all data to be written on one or more flash memory channels, while achieving parallel writing through multiple flash memory channels, thereby reducing the demand for buffer space for data writing.

Other features and aspects of the present disclosure will become apparent from the following detailed description of exemplary embodiments with reference to the drawings.

### BRIEF DESCRIPTION OF THE DRAWINGS

The drawings, which are incorporated in and constitute a part of the description, together with the description, illustrate exemplary embodiments, features, and aspects of the present disclosure and serve to explain the principles of the present disclosure . . . .

FIG. 1 is a schematic diagram showing a system for data transmission according to an embodiment of the present disclosure.

FIG. 2 is a flowchart of a method for data transmission according to an embodiment of the present disclosure.

FIG. 3 is a schematic diagram showing an address form according to an embodiment of the present disclosure.

FIG. 4 is a schematic diagram showing a format of a logical data block during data transmission according to an embodiment of the present disclosure.

FIG. 5 is a schematic diagram showing a controller according to an embodiment of the present disclosure.

### DETAILED DESCRIPTION

Various exemplary embodiments, features and aspects of the present disclosure will be explained in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

In addition, to better explain the present disclosure, numerous details are given in the following embodiments. It is appreciated by those skilled in the art that the present disclosure can still be implemented without some specific details. In some embodiments, methods, means, elements and circuits well known to those skilled in the art are not described in detail in order to highlight the gist of the present disclosure.

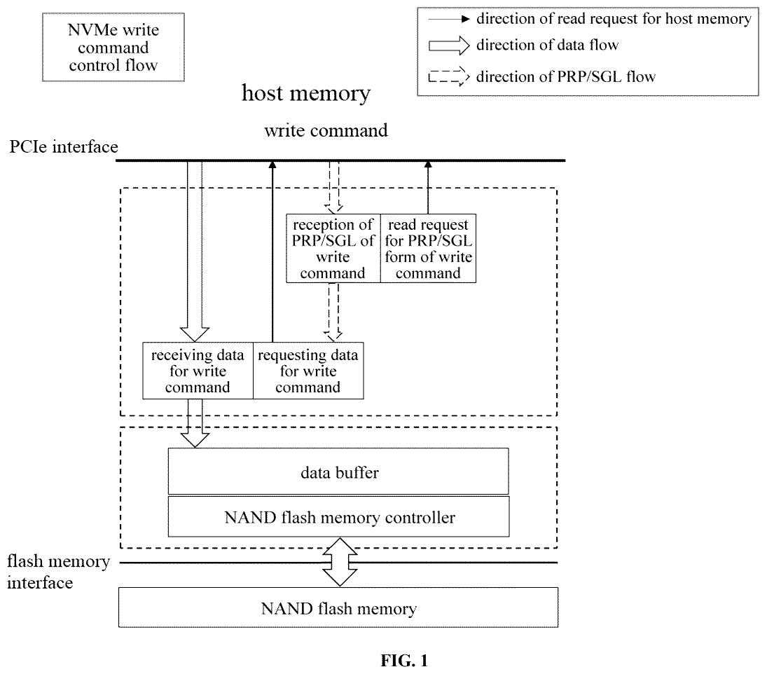

FIG. 1 is a schematic diagram showing a system for data transmission according to an embodiment of the present disclosure. As shown in FIG. 1, an embodiment of the present disclosure provides a system for data transmission, comprising a host memory, a host memory interface (e.g., a PCIe interface), a controller (a NAND flash memory controller), a flash memory interface, and a NAND flash memory, and configured to execute a method for data transmission according to an embodiment of the present disclosure through the controller to acquire a logical data block from the host memory through the PCIe interface, and write the logical data block into the NAND flash memory through the flash memory interface.

Optionally, each time data transmission is performed, the host memory may send a write command into the controller through the PCIe interface, and the controller requests a corresponding address form from the host memory based on the write command and then performs addressing based on the address form and requests to acquire data from the host memory. Further, the controller writes the data acquired from the host memory into the NAND flash memory through the flash memory interface and the flash memory channel.

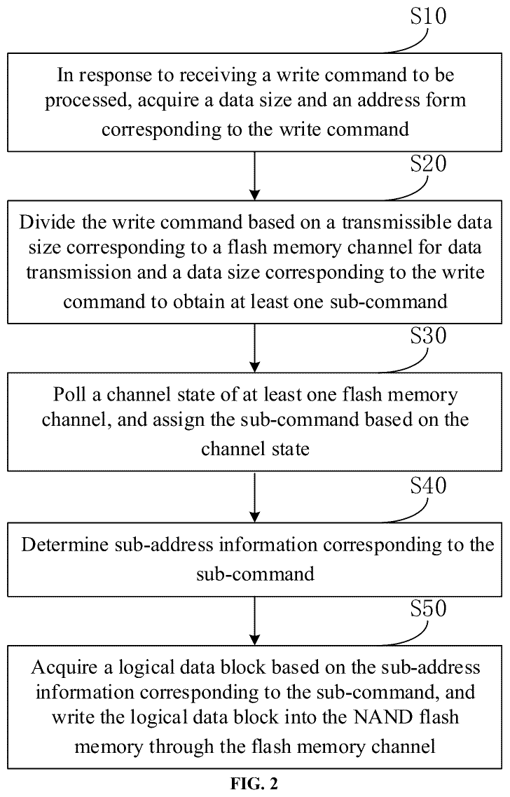

FIG. 2 shows a method for data transmission according to an embodiment of the present disclosure. In one exemplary application scenario, the method may be applied to the system for data transmission shown in FIG. 1; for example, the method may be executed by the controller in the system. As shown in FIG. 2, the method for data transmission according to an embodiment of the present disclosure may comprise the following steps S10 to S50.

In step S10, in response to receiving a write command to be processed, a data size and an address form corresponding to the write command are acquired.

In one possible implementation, according to an embodiment of the present disclosure, the method for data transmission is executed through the controller. Specifically, a write command to be processed transmitted through the host memory is received, and the write command is executed to transmit data stored in the host memory to the NAND flash memory, where the NAND flash memory is a non-transitory storage technology, that is, data may still be saved after power is cut off. After receiving the write command, the controller determines the data size and the address form corresponding to the write command, where the data size is a size of data to be written into the NAND flash memory based on the write command, and the address form is used to represent a storage address in the host memory for the data to be written into the NAND flash memory based on the write command. Optionally, a write command according to an embodiment of the present disclosure may be an NVMe (Non-Transitory Memory Express) command, and NVMe is a bus transmission protocol based on a logical interface of a device. NVMe specifies a standard protocol for accessing a non-transitory storage medium, such as a solid-state drive (SSD) with a flash memory, through a bus (typically the PCIe bus protocol), and is a protocol for communication between a host and the SSD.

Optionally, an address form in an embodiment of the present disclosure is used to represent a segment of data space in the host memory for storing data to be written, and the segment of data space may be a physically continuous space or a physically discontinuous data space. The host may pre-set a data form in the write command and then send the data form corresponding to the write command to the controller through the data transmission channel to inform the master control of a location in the host memory where a source of data to be written into the NAND flash memory is stored. The address form may be a form in the PRP (Physical Region Page) format or a form in the SGL (Scatter Gather List) format. In the PRP format, the host memory may be a collection of pages, and the page size may be 4 KB, 8 KB, 16 KB, . . . , 128 MB, etc. PRP is a 64-bit pointer to a physical address in the memory, which may include a memory page base address of several bits and a page address offset of several bits. The page address offset may be zero or a non-zero value. When the page address offset is zero, it indicates that the physical address is accessed in a page-aligned manner. There are two ways to address data to be written into the NAND flash memory based on the address form in the PRP format. One way is to address the data directly through the PRP pointer, and the other way is to address the data through the PRP list. In the case of addressing the data using the PRP List, the page offset must be zero, and each PRP entry represents a memory page.

Further, according to an embodiment of the present disclosure, the address form corresponding to the received write command may include two parts, including a start address for data to be written, and a data address list containing a plurality of storage addresses for the data to be written following the start address. The start address may be addressed directly through the PRP pointer, and the data address list may be used for addressing through the PRP list.

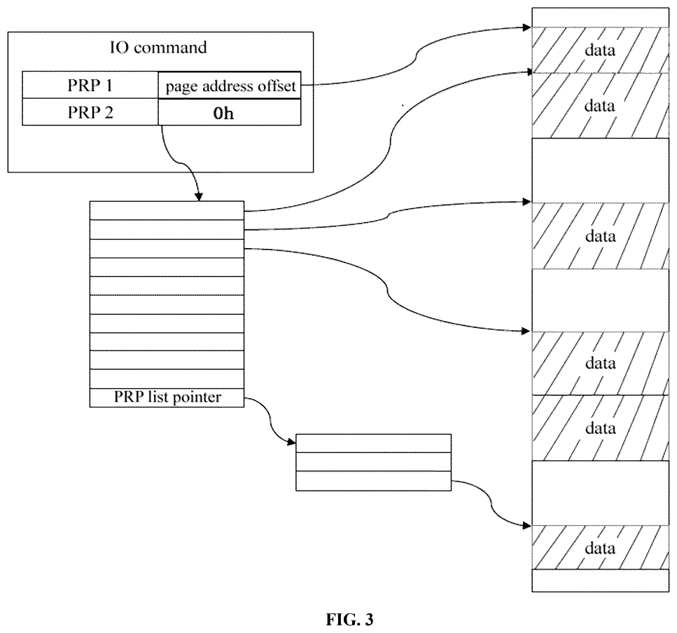

FIG. 3 is a schematic diagram showing an address form according to an embodiment of the present disclosure. As shown in FIG. 3, when the address form in an embodiment of the present disclosure is a form in the PRP format, it may include a start address PRP1 and a data address list PRP2, and the host uses these two fields to inform the controller of a location of data to be written in the host memory. PRP1 describes a start address of a contiguous physical memory within a page, and PRP2 includes PRP addresses that describe contiguous or non-contiguous physical memory of several pages, i.e., multiple storage addresses for the data to be written.

In step S20, the write command is divided based on a transmissible data size corresponding to a flash memory channel for data transmission, and a data size corresponding to the write command to obtain at least one sub-command.

In one possible implementation, after receiving the write command, the data size corresponding to the write command may be compared with a transmissible data size of at least one flash memory channel for information and data transmission to determine whether to divide the write command. Optionally, if the overall data size corresponding to the write command is smaller than or equal to the transmissible data size of one flash memory channel, it is determined that one flash memory channel is able to completely process the write command, so there is no need to divide the write command, and the write command may be directly executed. If the data size corresponding to the write command is larger than the transmissible data size of one flash memory channel, a single flash memory channel is unable to completely process the write command, so the write command needs to be divided into at least one sub-command such that a sub-command may be completely executed through each flash memory channel at each data transmission.

Optionally, the controller may divide the write command based on the transmissible data size and the data size such that the sub-data size corresponding to each write command does not exceed the transmissible data size of the data transmission of the flash memory channel, that is, as a result of the division, the sub-data size corresponding to each sub-command is smaller than or equal to the transmissible data size.

In step S30, a channel state of at least one flash memory channel is polled, and the sub-command is assigned based on the channel state.

In one possible implementation, after the write command is divided into a plurality of sub-commands, the controller performs assignment and processing of the sub-commands by polling the channel state of each flash memory channel for performing command processing. The channel state of each flash memory channel may be determined by a counter and represented as a count value that indicates a degree of idleness. The smaller the count value corresponding to the channel state, the higher the degree of idleness, and the greater the count value corresponding to the channel state, the lower the degree of idleness. Optionally, a sub-command to be processed on each flash memory channel is managed by a command queue. When a sub-command is sent to the command queue of a channel, a count value of a command counter increases, and when a sub-command is completed, the count value of the command counter decreases. The higher the count value of the command counter, the busier the channel, and the lower the count value of the command counter, the more idle the channel, with a count value of zero indicating that the channel is completely idle. The counter may be implemented by hardware or firmware. If the counter is implemented by hardware, a firmware control interface may be additionally provided to allow firmware to dynamically adjust the count value of the counter, thereby increasing flexibility.

Optionally, the controller may assign the sub-command based on the degree of idleness of each flash memory channel and a preset assignment rule. By way of example, in the presence of a flash memory channel with the channel state being completely idle, a sub-task may be assigned to a flash memory channel. In the absence of a flash memory channel with the channel state being completely idle, a sub-task is assigned to at least one flash memory channel with the channel state having a highest degree of idleness. That is, if there is a flash memory channel with a corresponding count value of zero, a sub-task is assigned to the flash memory channel; and if there is no flash memory channel with a corresponding count value of zero, a sub-task may be assigned to each flash memory channel with the lowest count value.

In step S40, sub-address information corresponding to the sub-command is determined.

In one possible implementation, for the flash memory channel to which the sub-command has been assigned, the controller acquires sub-address information corresponding to the sub-command to execute the corresponding sub-command. Optionally, an acquisition order of the sub-address information may be determined based on the degree of idleness of the flash memory channel, that is, in the polling process, the controller not only assigns a flash memory channel to process each sub-task based on the value of the command counter, which indicates the channel state of the flash memory channel, but also executes the sub-task based on the channel state of the flash memory channel. A channel with a value of zero of the command counter has the highest priority in scheduling, and then priorities are assigned in order of increasing values. When a plurality of channels have the same and minimum values of the command counter, a polling scheduling mechanism may be used to ensure fairness in scheduling. By way of example, the controller may pre-fetch the sub-address information required for the corresponding flash memory channel based on the order of scheduling. This scheduling mechanism takes into account the idle state of the flash memory channel, such that a more idle channel has a greater chance of determining the sub-address information first. At the initial stage, all flash memory channels are idle, and the polling mechanism will first select some idle channels to pre-fetch sub-address information. Through this mechanism, the order and timing of acquiring the sub-address information may be reasonably arranged based on the idle state of the flash memory channels, which helps to avoid the situation that the sub-address information is not acquired in time and also reduces the likelihood of occurrence of idle time of the flash memory channel during data transmission.

Further, the sub-address information corresponding to each sub-command is essentially acquired by dividing the data address list of a write command into a plurality of address list segments, where each address list segment is used to record the storage address in the host memory for the logical data block to be written based on the corresponding write command. Within each address list segment, the storage address may be sequentially extracted based on the corresponding logical data block. Between different address list segments, the idle state of the flash memory channel may be monitored by polling the flash memory channel to determine the acquisition order of data corresponding to a next sub-command.

Optionally, the sub-address information corresponding to the sub-command to be executed by each flash memory channel may include a position of a sub-start address corresponding to each sub-command, and a corresponding page offset. The position of the sub-start address is used to represent the start address in the data address list for the data address where the data to be transmitted based on the sub-command is stored, and the page offset is used to represent the offset amount of the data address of the data to be transmitted based on the sub-command from the start address in the data address list. For a first processed sub-command, an electronic apparatus may directly determine its corresponding sub-start address to be zero, and its corresponding page offset to be the page offset of the start address. For subsequently processed sub-commands, the electronic apparatus may calculate the sub-start address and the corresponding page offset based on seg_prp_ptr=Mod((seg_size*seg_num+prp_ofst−seg_ofst)/page_size) and seg_prp_ofst=|(seg_size*seg_num+prp_ofst−seg_ofst)/page_size|, respectively, where seg_size represents a sub-data size corresponding to the sub-command, seg_num represents an execution order corresponding to the sub-command, prp_ofst represents a page offset of the start address, seg_ofst represents an offset of a logical data block corresponding to a first sub-command, and page_size represents a size of a data page that stores the data address list.

Further, based on the sub-address information corresponding to each sub-command, the data to be written corresponding to the write command may be divided into logical data blocks corresponding to respective sub-commands. This enables the data to be written to be transmitted in blocks by sequentially executing the sub-commands, such that the logical data block transmitted during the execution of each sub-command is smaller than or equal to the transmissible data size of the flash memory channel. Since the size of the logical data block is determined based on the transmissible data size of the flash memory channel, the logical data block corresponding to the first sub-command of the write command and the logical data block corresponding to the last sub-command of the write command may be smaller than a transmissible data size, and the sizes of logical data blocks corresponding to the remaining sub-commands may be equal to the transmissible data size.

In step S50, a logical data block is acquired based on the sub-address information corresponding to the sub-command, and the logical data block is written into the NAND flash memory through the flash memory channel.

In one possible implementation, during execution of a sub-command, the controller first determines the sub-address information corresponding to the sub-command to perform addressing based on the corresponding sub-address information, acquires a logical data block stored in the host memory, and then writes the logical data block to the NAND flash memory through a flash memory channel corresponding to the sub-command, i.e., a flash memory channel that executes the sub-command. Optionally, during data transmission, the controller may further divide the logical data block based on a preset size to obtain a plurality of data units, and the flash memory channel performs data transmission in units of data units.

FIG. 4 is a schematic diagram showing a format of a logical data block during data transmission according to an embodiment of the present disclosure. As shown in FIG. 4, the controller divides the data to be written in the host memory into a plurality of logical data blocks (LDBs) for data transmission by dividing the write command into a plurality of sub-commands and determining sub-address information corresponding to the sub-commands. For each logical data block, the controller further divides it into a plurality of data units (DUs). Each DU is divided based on an integer multiple of the logical block (LB), and each DU contains a plurality of logical blocks. A first DU of each first LDB and a last DU of each last LDB may be smaller than a size of a complete DU, and such data units are referred to as “partial data units” (Partial DUs). When data transmission is performed for each sub-command of the write command, data is transmitted in units of data units (DUs).

Based on the above technical features, according to an embodiment of the present disclosure, in response to receiving a write command, the write command may be divided into a plurality of sub-commands, and then sub-address information is calculated for each sub-command to divide data into a plurality of logical data blocks, such that each logical data block corresponds to data to be written into a flash memory channel. Within the logical block, the controller acquires data to be written from the host memory in the order of the logical data blocks. Between the logical blocks, the controller uses the polling mechanism to determine a next logical block that needs to acquire the data to be written. Through this data transmission method, the present disclosure avoids the need for hardware to store all data to be written on one or more flash memory channels, while achieving parallel writing of data through multiple flash memory channels, thereby significantly reducing the demand for buffer space for data writing and thus enhancing the write performance of the flash memory channel.

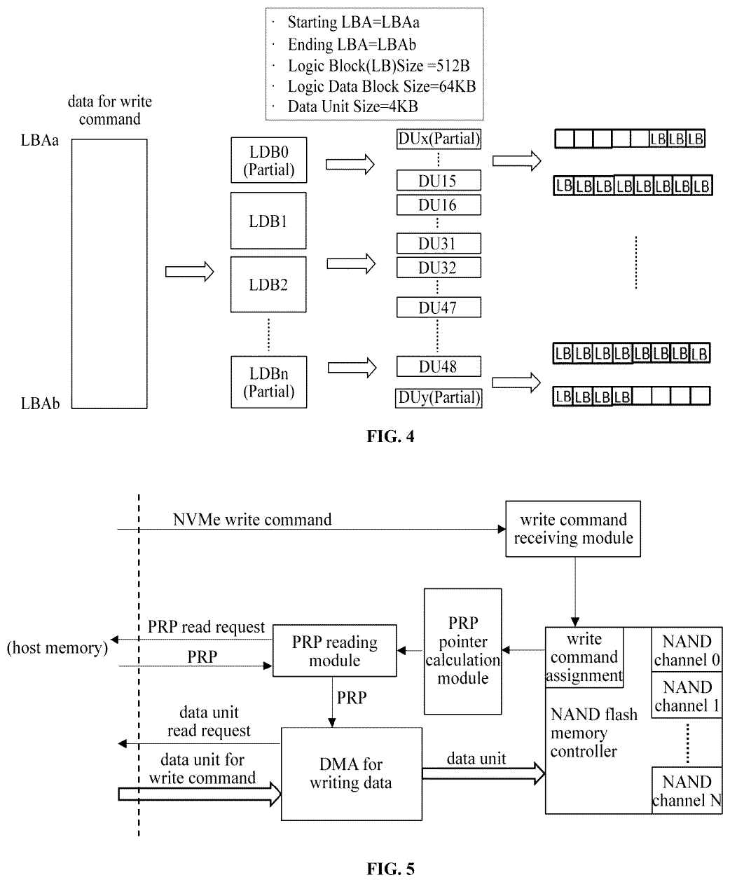

FIG. 5 is a schematic diagram showing a controller according to an embodiment of the present disclosure. As shown in FIG. 5, the controller according to an embodiment of the present disclosure may comprise:
a write command receiving module configured to receive a write command in a host memory and acquire a data size and an address form corresponding to the write command;
a NAND flash memory controller configured to divide the write command based on a transmissible data size corresponding to a flash memory channel for data transmission and a data size corresponding to the write command to obtain at least one sub-command;
a PRP pointer calculation module configured to determine sub-address information corresponding to each sub-command;
a PRP address reading module configured to acquire a storage address for a logical data block corresponding to the sub-command based on the sub-address information; and
a data writing module configured to read a corresponding logical data block from the host memory based on the storage address for the logical data block,
where the NAND flash memory controller is further configured to receive the logical data block and write the logical data block into a corresponding flash memory channel to write the logical data block to a NAND flash memory through the flash memory channel.

In some embodiments, the functions of or the modules included in the device according to an embodiment of the present disclosure may be configured to carry out the methods described in the above method embodiments, the specific implementation of which may refer to the description of the above method embodiments and will not be repeated herein for the sake of brevity.

According to an embodiment of the present disclosure, a computer readable storage medium is further provided, storing computer program instructions thereon, which, when executed by a processor, implements the above method. The computer readable storage medium may be a transitory or non-transitory computer readable storage medium.

According to an embodiment of the present disclosure, an electronic apparatus is further provided, comprising: a processor; and a memory for storing processor executable instructions, where the processor is configured to, when executing the instructions stored in the storage, implement the above method.

According to an embodiment of the present disclosure, a computer program product is further provided, comprising computer readable code, or a non-transitory computer readable storage medium carrying computer readable code, where when the computer readable code runs in a processor of an electronic apparatus, the processor of the electronic apparatus executes the above method.

The present disclosure may be implemented by a system, a method, and/or a computer program product. The computer program product may include a computer readable storage medium having computer readable program instructions for causing a processor to implement the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. More specific examples (a non-exhaustive list) of the computer readable storage medium include: portable computer disk, hard disk, random access memory (RAM), read-only memory (ROM), erasable programmable read-only memory (EPROM or flash memory), static random access memory (SRAM), portable compact disc read-only memory (CD-ROM), digital versatile disk (DVD), memory stick, floppy disk, mechanically encoded device (for example, punch-cards or raised structures in a groove having instructions stored thereon), and any proper combination thereof. A computer readable storage medium used herein should not to be construed as transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical fiber transmission, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the individual computing/processing devices.

Computer readable program instructions for carrying out the operations of the present disclosure may be assembly instructions, instruction-set-architecture (ISA) instructions, machine instructions, machine-related instructions, microcode, firmware instructions, state setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with a remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions, and the electronic circuitry may execute the computer readable program instructions, so as to achieve the aspects of the present disclosure.

Aspects of the present disclosure have been described herein with reference to the flowchart and/or the block diagram of the method, device (systems), and computer program product according to an embodiment of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions, when executed by the processor of the computer or other programmable data processing devices, create means for implementing the functions/acts specified in one or more blocks in the flowchart and/or block diagram. These computer readable program instructions may also be stored in a computer readable storage medium, where the instructions cause a computer, a programmable data processing device and/or other devices to function in a particular manner, such that the computer readable storage medium having instructions stored therein comprises a product that includes instructions for implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable data processing devices or other devices, so as to produce a computer implemented process, such that the instructions executed on the computer, other programmable data processing devices or other devices implement the functions/acts specified in one or more blocks in the flowchart and/or block diagram.

The flowchart and block diagram in the drawings illustrate the architecture, function, and operation that may be implemented by the system, method and computer program product according to various embodiments of the present disclosure. In this regard, each block in the flowchart or block diagram may represent a module, a program segment, or a portion of instructions, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It should also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

Although an embodiment of the present disclosure have been described above, it will be appreciated that the above description is merely exemplary, but not exhaustive, and is not limited to the disclosed embodiments. A number of variations and modifications may occur to one skilled in the art without departing from the scopes and spirits of the described embodiments. The terms used herein are selected to provide the best explanation on the principles, practical applications, or technical improvements in the market of the embodiments, or to enable one skilled in the art to understand the embodiments disclosed herein.

1. A method for data transmission, comprising:
acquiring, in response to receiving a write command to be processed, a data size and an address form corresponding to the write command;
dividing the write command based on a transmissible data size corresponding to a flash memory channel for data transmission and the data size corresponding to the write command to obtain at least one sub-command, each of which has a corresponding sub-data size;
polling a channel state of at least one flash memory channel and assigning the sub-command based on the channel state;
determining sub-address information corresponding to the sub-command; and
acquiring a logical data block based on the sub-address information corresponding to the sub-command, and writing the logical data block into a NAND flash memory through the flash memory channel.

2. The method according to claim 1, wherein the address form comprises a start address for data to be written, and a data address list containing a plurality of storage addresses for the data to be written following the start address.

3. The method according to claim 2, wherein determining the sub-address information corresponding to the sub-command comprises:
calculating a sub-start address and a corresponding page offset based on seg_prp_ptr=Mod((seg_size*seg_num+prp_ofst−seg_ofst)/page_size) and seg_prp_ofst=|(seg_size*seg_num+prp_ofst−seg_ofst)/page_size|, respectively, wherein seg_size represents a sub-data size corresponding to the sub-command, seg_num represents an execution order corresponding to the sub-command, prp_ofst represents a page offset of the start address, seg_ofst represents an offset of a logical data block corresponding to a first sub-command, and page_size represents a size of a data page that stores the data address list; and
determining corresponding sub-address information based on a position of the sub-start address and the page offset corresponding to the sub-command.

4. The method according to claim 1, wherein the sub-data size corresponding to the sub-command is smaller than or equal to the transmissible data size.

5. The method according to claim 1, wherein polling the channel state of the at least one flash memory channel and assigning the sub-command based on the channel state comprises:
in response to presence of a flash memory channel with the channel state being completely idle, assigning a sub-task to the flash memory channel; and
in response to absence of a flash memory channel with the channel state being completely idle, assigning a sub-task to at least one flash memory channel with the channel state having a highest degree of idleness.

6. The method according to claim 1, wherein the method further comprises:
dividing the logical data block based on a preset size to obtain a plurality of sub-logical data blocks; and
performing, by the flash memory channel, data transmission in units of the sub-logical data blocks.

7. The method according to claim 1, wherein the channel state is determined based on a count of a command counter, and the smaller a count value corresponding to the channel state, the higher a degree of idleness.

8. A controller, comprising:
a write command receiving module configured to receive a write command in a host memory and acquire a data size and an address form corresponding to the write command;
a NAND flash memory controller configured to divide the write command based on a transmissible data size corresponding to a flash memory channel for data transmission and the data size corresponding to the write command to obtain at least one sub-command;
a Physical Region Page (PRP) pointer calculation module configured to determine sub-address information corresponding to each sub-command;
a PRP address reading module configured to acquire a storage address for a logical data block corresponding to the sub-command based on the sub-address information; and
a data writing module configured to read a corresponding logical data block from the host memory based on the storage address for the logical data block,
wherein the NAND flash memory controller is further configured to receive the logical data block and write the logical data block into a corresponding flash memory channel to write the logical data block into a NAND flash memory through the flash memory channel.

9. (canceled)

10. A non-transitory computer readable storage medium storing computer program instructions thereon, wherein in response to the computer program instructions being executed by a processor, a controller in the processor implements a method for data transmission, the method comprising:
acquiring, in response to receiving a write command to be processed, a data size and an address form corresponding to the write command;
dividing the write command based on a transmissible data size corresponding to a flash memory channel for data transmission and the data size corresponding to the write command to obtain at least one sub-command, each of which has a corresponding sub-data size;
polling a channel state of at least one flash memory channel and assigning the sub-command based on the channel state;
determining sub-address information corresponding to the sub-command; and
acquiring a logical data block based on the sub-address information corresponding to the sub-command, and writing the logical data block into a NAND flash memory through the flash memory channel.

11. The non-transitory computer readable storage medium according to claim 10, wherein the address form comprises a start address for data to be written, and a data address list containing a plurality of storage addresses for the data to be written following the start address.

12. The non-transitory computer readable storage medium according to claim 11, wherein determining the sub-address information corresponding to the sub-command comprises:
calculating a sub-start address and a corresponding page offset based on seg_prp_ptr=Mod((seg_size*seg_num+prp_ofst−seg_ofst)/page_size) and seg_prp_ofst=|(seg_size*seg_num+prp_ofst−seg_ofst)/page_size|, respectively, wherein seg_size represents a sub-data size corresponding to the sub-command, seg_num represents an execution order corresponding to the sub-command, prp_ofst represents a page offset of the start address, seg_ofst represents an offset of a logical data block corresponding to a first sub-command, and page_size represents a size of a data page that stores the data address list; and
determining corresponding sub-address information based on a position of the sub-start address and the page offset corresponding to the sub-command.

13. The non-transitory computer readable storage medium according to claim 10, wherein the sub-data size corresponding to the sub-command is smaller than or equal to the transmissible data size.

14. The non-transitory computer readable storage medium according to claim 10, wherein polling the channel state of the at least one flash memory channel and assigning the sub-command based on the channel state comprises:
in response to presence of a flash memory channel with the channel state being completely idle, assigning a sub-task to the flash memory channel; and
in response to absence of a flash memory channel with the channel state being completely idle, assigning a sub-task to at least one flash memory channel with the channel state having a highest degree of idleness.

15. The non-transitory computer readable storage medium according to claim 10, wherein the method further comprises:
dividing the logical data block based on a preset size to obtain a plurality of sub-logical data blocks; and
performing, by the flash memory channel, data transmission in units of the sub-logical data blocks.

16. The non-transitory computer readable storage medium according to claim 10, wherein the channel state is determined based on a count of a command counter, and the smaller a count value corresponding to the channel state, the higher a degree of idleness.
